(19) United States
(12) Patent Application Publication
(10) Pub. No.: US 2015/0317579 A1
(43) Pub. Date: Nov. 5, 2015

(54) METHOD OF GENERATING FEEDBACK FOR PROJECT PORTFOLIO MANAGEMENT

(71) Applicant: Gary J. Summers, Port Washington, NY (US)

(72) Inventor: Gary J. Summers, Port Washington, NY (US)

(21) Appl. No.: 14/703,368

(22) Filed: May 4, 2015

Related U.S. Application Data
(63) Continuation of application No. 12/614,800, filed on Nov. 9, 2009.

(51) Int. Cl. G06Q 10/06

(52) U.S. Cl. CPC G06Q 10/0637; G06Q 10/06375

(57) ABSTRACT

A computer executable method for producing a feedback metric for use in Project Portfolio Management (“PPM”). The method includes collecting data about a plurality of project proposals and collecting data about a plurality of completed projects, such that some of the data about proposals and completed projects pertain to the same project. The collected data is then used to estimate the parameters of a model by using a maximum likelihood technique, executed as an algorithm in the computer, that overcomes a Missing Data Problem (“MDP”). The method uses the estimated parameters generated by the algorithm to create feedback metrics for use in PPM and that are output from the computer.

### CROSS-REFERENCE TO PRIOR APPLICATION

This application is a continuation of U.S. patent application Ser. No. 12/614,800, filed Nov. 9, 2009 which hereby incorporated be reference in the entirety.

### FIELD OF THE INVENTION

The invention relates to project portfolio management (PPM), and more specifically, to a method for analyzing a PPM implementation to provide feedback for evaluating PPM and to aid decision-making in future PPM implementations.

### BACKGROUND OF THE INVENTION

In organizations, executives use project portfolio management (PPM) to implement strategy, allocate resources, manage risk and achieve goals. Without PPM an organization's projects lack focus and the organization commits resources to the wrong goals. Typically, the organization's portfolio becomes overloaded and filled with projects of mediocre value. Cycle-time increases, the quality of work suffers and projects success rates fall. Freed from the discipline of PPM, resources are often allocated by politics, emotion and inertia, and the organization's strategy goes adrift.

Because of its importance, PPM has a long history of research and practice. Academics have been developing PPM tools and models for more than 40 years. The business literature offers numerous white papers. Scholars and companies have benchmarked best practices. Professional organizations have designated standards. A large software industry exists to supply companies with PPM tools. Finally, numerous patent and patent applications describe methods of doing PPM. For instance, reference can be made to U.S. Pat. Nos. 6,578,004; 7,158,940; and patent application Ser. Nos.: 10/136,800; 10/220,134; 10/745,837; 10/745,892; 11/058,107; 11/164,035; 11/187,838; 11/215,244; 11/295,828; and 11/493,442.

Reference is made to FIG. 1, which illustrates a PPM example, but it is not to be understood to define PPM or limit the current invention in any way. While those of ordinary skill in PPM will recognize FIG. 1, they are also aware of other known methods and variations of doing PPM.

The PPM illustrated by FIG. 1 starts at step 105, where executives develop an organization's strategy. At step 110 various members of the organization propose projects. These two steps are ongoing processes, meaning they operate continuously in an organization. Using the developed strategy, PPM executives evaluate the proposals (step 115). Subsequently, in many PPM implementations, the PPM executives prioritize the proposals (step 120). Then they select proposals to implement (step 125) and allocate resources to the selected proposals (step 130). The selected proposals are then executed (step 135), thereby creating a portfolio of projects. While the projects are being executed, the PPM executives monitor their progress and compare it to the organization's strategic goals. If needed, the PPM executives make adjustments. For example, they can add a project, cancel a project or adjust the allocation of resources among projects. For an example of this monitoring step, see patent application Ser. No. 11/164,035.

Sometimes PPM executives evaluate each completed project. For each completed project, they compare the project's results to the expectations and goals that the organization had for the project's proposal. Did the project achieve its goals? Did it contribute to the company as expected? These evaluations occur in step 145. However, step 145 is often omitted, in both the PPM literature and in practice. For a discussion of this omission, see Stephen Rietiker's article “In Search of Project Portfolio Management Processes,” which is available at maxwideman.com/guests/pm_processes/intro.htm.

In FIG. 1, step 145 is not listed in the loop that occurs over steps 115 through 140. This is because the evaluation of completed projects need not be temporally coordinated with the evaluation and selection of projects. For example, a company can perform steps 115 through 140 once every six months. Meanwhile, it can evaluate its executed projects (performing step 145) after the projects are completed. The projects may require more than six months to complete.

### SUMMARY OF THE INVENTION

In one aspect, a computer-implemented method for producing a feedback metric in connection with Project Portfolio Management (“PPM”) is described in which an aspect of the PPM is modeled by using data collected into a memory about a plurality of project proposals and a plurality of completed projects, including both before-project and after-project data. Estimated parameters are generated for modeling an aspect of the PPM by using a maximum likelihood algorithm that configures a processor of the computer to overcome a Missing Data Problem (“MDP”). A feedback metric is produced using at least one of the estimated parameters and output from the computer.

In further, optional aspects, the foregoing method can include the additional step of using the computer to display a generated estimated parameter and storing the estimated parameter into the memory of the computer for use by another computer-implemented method. Also, the step of the producing the feedback metric can further include generating data points from the generated estimated parameters and presenting the data points to a user. As well, the generating step can include the step of performing logistic regression to generate the estimated parameters or applying an EM algorithm, and can further include fitting the collected data to a Signal Detection Theory (SDT) model. An embodiment of the invention can implement one or more of these optional aspects.

In a further aspect, a computer program product comprises a computer useable medium having control logic stored therein for causing a computer to generate a feedback metric for use in PPM by modeling an aspect of PPM. The control logic comprises three computer readable program code portions. A first computer readable program code causes the computer to analyze data from a plurality of proposal evaluations and results from a plurality of completed projects, the data comprising before-and-after data for a plurality of projects, the proposals and completed projects originating from at least one appropriate PPM implementation. A second computer readable program code causes the computer to estimate the parameters of the model by using a maximum likelihood technique that overcomes the MDP in PPM. A third computer readable program code causes the computer to produce the feedback metric by using at least one said estimated parameter.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a flowchart of a PPM process;

FIG. 2 is a table depicting the outcomes of project selection;

FIG. 3 is a table depicting how the missing data problem affects the counting of the outcomes of project selection;

FIG. 4 is a flowchart of a process for providing PPM feedback;

FIG. 5 is a graph depicting how the quality of proposals affects both PPM results and the difficulty of project selection;

FIG. 6 is a table depicting variables that measure the ability to identify Good proposals and the ability to identify Bad proposals;

FIG. 7 is a graphic that shows how uncertainty affects the ability to correctly prioritize (rank) projects;

FIG. 8 is a graphic that shows how uncertainty affects the relationship between a proposal's position in a ranking and the proposal's probability of being a Good proposal.

FIG. 9 is a graph that illustrates two prioritization curves;

FIG. 10 is a graph depicting the signal detection theory model;

FIG. 11 is a table depicting the information that is used to calculate PPM metrics in the illustrated embodiment;

FIG. 12 is a flowchart depicting how to fit a signal detection theory model to PPM data;

FIG. 13 is a table depicting a feedback metric that presents estimates of P_{Proposals} for three strategic buckets;

FIG. 14 is a graph illustrating a feedback metric that displays prioritization curves for three strategic buckets;

FIG. 15 is graph of a function that relates a proposal's score to the probability that the proposal will produce a successful project;

FIG. 16 is a chart depicting the probability of success for various proposals. For some of these proposals the chart shows the probabilities of success that result from different levels of resource commitments; and

FIG. 17 is a picture illustrating the modification of a scale on which proposals are evaluated.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

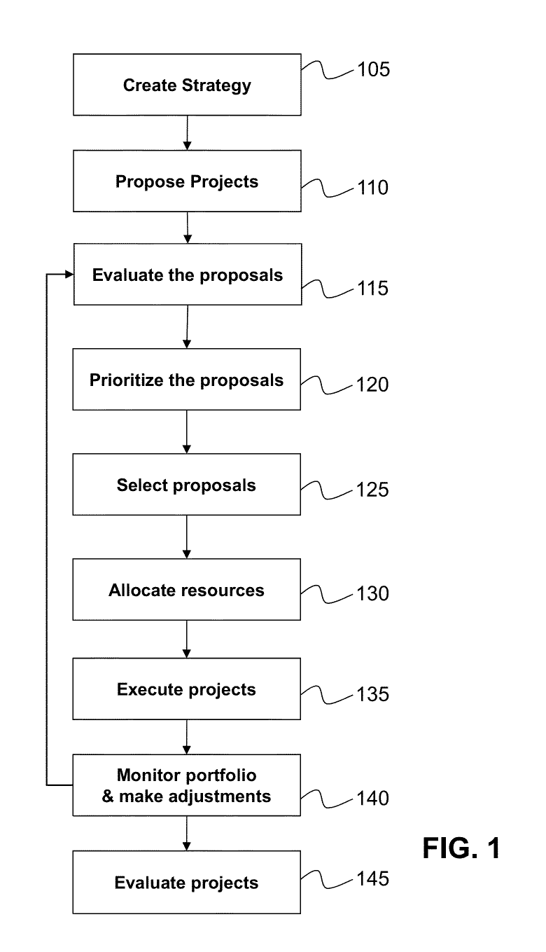

By way of overview and introduction, an application of PPM is called a PPM implementation. In FIG. 1, steps 115 through 140 depict such a PPM implementation. It is to be understood that the arrow connecting step 140 to step 115 starts a new implementation. While FIG. 1 illustrates a PPM implementation, it is not a defining case. As previously mentioned, there are many ways of performing PPM. Generally, a PPM implementation includes evaluating proposals, selecting proposals, allocating resources to the selected proposals and starting to execute the selected proposals. Some companies repeat this process periodically. For example, a company that performs this process biannually performs two implementations of PPM typically each year. Other companies apply this process continuously. In these cases, an implementation can be defined by a time interval, such as one year of doing PPM.

Furthermore, if the results of a PPM implementation are evaluated, a project that is executed is preferably evaluated (at least) twice: once before project selection and again after the project is started. Often, this second evaluation occurs after a project is completed. When a project is evaluated before selection (as in step 115 of FIG. 1), it is to be referred to as a proposal. When a project is evaluated after it is started (as in step 145 of FIG. 1), it is to be referred to as a completed project. It is to be understood that these terms are used for simplification, even though some proposals and “completed” projects are ongoing projects. Additionally, a proposal that is implemented is referred to as a selected proposal. A proposal that is not implemented is referred to as a rejected proposal.

It is to be also appreciated that when describing the invention, standard nomenclature is used when it is unambiguous. For example, rather than use the term “proposal selection,” the common term “project selection” may be used. Likewise, the evaluation of proposals may, or may not, be referred to by its common term “project evaluation” as well.

In FIG. 1, step 140 assesses the progress of a portfolio and adjusts the portfolio as needed. Meanwhile, step 145 evaluates the completed projects. Neither step 140 nor step 145 is the same as evaluating PPM itself. One difference is the purpose of the steps. Step 140 evaluates the portfolio to determine if it's producing the desired goals. Step 145 evaluates completed projects to determine if each completed project achieved its goals. In contrast, an evaluation of PPM evaluates one or more of the steps of PPM, such one or more of steps 105, 110, 115, 120, 125 and 130.

Furthermore, the method of evaluating PPM differs from the methods of performing steps 140 and 145. Step 140 uses data that results from the execution of projects. In contrast, an evaluation of PPM uses data that arises from the execution of projects and it also uses data that arises from the evaluation of proposals (step 115). Step 145 uses data from both the completed projects and the proposals, but the step considers each project individually. In step 145, the evaluation of each project is a separate calculation. In contrast, to evaluate PPM one must perform calculations that use data from a plurality of projects.

Finally, the evaluation of PPM differs from step 140 and step 145 in still another way. The evaluation of PPM must use calculations that overcome the missing data problem in PPM. Steps 140 and 145 do not encounter a missing data problem and they need not, and do not use calculations for overcoming this problem. This missing data problem is described and illustrated below.

The evaluation of PPM produces metrics that evaluate one or more steps of PPM. These metrics are generally referred to as PPM feedback and the metrics themselves are referred to as feedback metrics. PPM feedback provides companies with two primary benefits. First, PPM feedback can evaluate one or more steps of PPM, so that managers know how the steps contribute to the overall process and whether a step should be improved. When PPM feedback is used to evaluate a step in PPM, I refer to the feedback metric an evaluation metric. Second, because PPM feedback is derived from PPM results, it reveals the performance of an organization's PPM. This information can be useful when performing future implementations of PPM. When a feedback metric is used for this purpose, the metric is referred to as a performance-based metric. An embodiment of the current invention can produce one or more evaluation metrics or performance-based metrics. These metrics can evaluate or inform any step of PPM.

Performance-based metrics are different than the metrics that are commonly used in PPM. The commonly used metrics are based on expectations about the current set of proposals. These expectations are subjective estimates. In contrast, performance-based metrics come from analyzing PPM results. They provide objective estimates of what the organization can achieve with PPM. Because they are objective, performance-based metrics compliment the subjective metrics that are currently used in PPM.

Despite more than forty years of academic research and decades of investment in PPM, the field of PPM lacks methods for producing PPM feedback. This is because when PPM results are analyzed, a missing data problem arises which has heretofore gone unaddressed in the art.

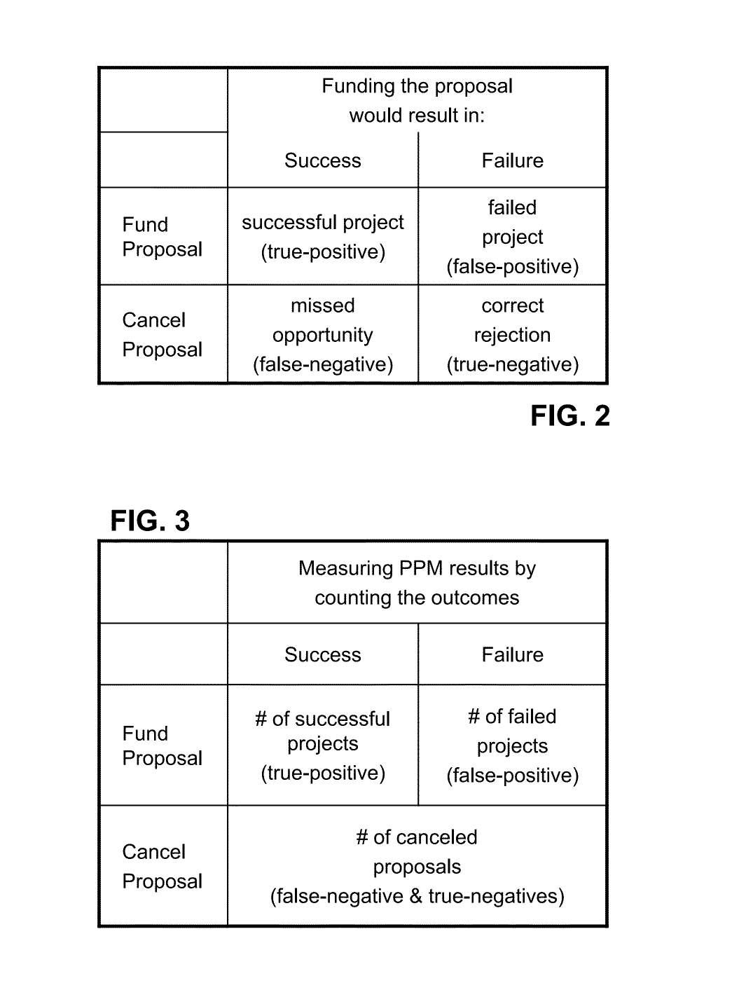

FIGS. 2 and 3 illustrate this missing data problem. To understand these tables, suppose that a project can either succeed or fail. When executives perform PPM, they evaluate proposals (as in step 115 in FIG. 1). For each proposal, the executives predict whether implementing the proposal produces a successful project or a failure. Based on their evaluations, the executives select some proposals and reject the remaining proposals. As FIG. 2 illustrates, their decisions have four possible outcomes: true-positive, false-positive, false-negative and true-negative.

In an ideal world, one could generate feedback metrics by classifying the decision for each proposal into one of the four outcomes. However, this evaluation procedure is impossible to perform, and FIG. 3 illustrates the reason. By reviewing the completed projects, one can count the number of true-positives and false-positives. Likewise, one can count the total number of rejected proposals. Unfortunately, one cannot know which rejected proposals are true-negatives and which are false-negatives. The results that would have been produced, had the rejected proposals been selected, cannot be known. This information is missing. Stated in the terms of statistics, the analysis of PPM results encounters the aforesaid missing data problem.

In addition to the tables in FIGS. 2 and 3, one can see the missing data problem by describing the analysis of PPM results in the following statistical terms. The set of proposals is a population. The selected proposals constitute a sample from the population. One can analyze the sample to reveal qualities of the population, such as the quality of the proposals or the quality of the project evaluations. However, PPM does not select proposals randomly. Instead, PPM executives strive to select the proposals that contribute the most to their organization's strategy and financial performance. This is a sample selection bias. Because the sample selection bias, one cannot analyze the sample with common statistical techniques. Instead, one must use statistical techniques that overcome the sample selection bias. In PPM the sample bias and the missing data problem are the same problem. (The sample is biased because some of the data is missing, or data is missing because there is a sample bias.) Missing data problems are described in R. Little and D. Rubin's book Statistical Analysis with Missing Data, 2^{nd} edition, (2002, New York: Wiley).

In sum, when generating PPM feedback one confronts a particular type of missing data problem. This missing data problem arises from two qualities of PPM: (1) PPM only selects a portion (less than 100%) of the proposals that are evaluated and (2) proposals are not selected randomly. These two qualities define the missing data problem for PPM, which are referred to as the MDP for PPM. The existence of the MPD for PPM complicates the analysis of PPM results. Previously, those skilled in the PPM art did not recognize this problem, and as a result, the art could not produce useful PPM feedback. The present invention advances the field by providing a method for producing PPM feedback.

When producing feedback metrics, the particular qualities of an embodiment depend upon the metric(s) a person desires to produce. For example, the data that is gathered and the algorithm used to process that data depend upon the desired feedback metric(s). Furthermore, a particular embodiment can only be used to analyze some PPM implementations. For example, the illustrated embodiment presented below can only be used with PPM implementations that evaluate proposals on an interval or a ratio scale. The PPM implementations that can be analyzed by a particular embodiment are called appropriate PPM implementations.

While the particulars of each embodiment can vary, all embodiments follow a general procedure. An embodiment produces a feedback metric(s) by modeling some aspect of PPM. The model relates a quality of the PPM process to a quality of the PPM results. A quality of the PPM process can be a quality of a step, part of a step or an entire step in PPM. For example, it can be a quality of strategy (step 105 in FIG. 1), a procedure in the proposal processes, a component of a project evaluation model (such as attribute weights) or a step in a method for selecting proposals. A quality of PPM results can be any quality of the completed projects, such as a quality of completed projects, of a portfolio of completed projects, or the realized strategy or of the impact on business processes (such as a Stage-Gate system).

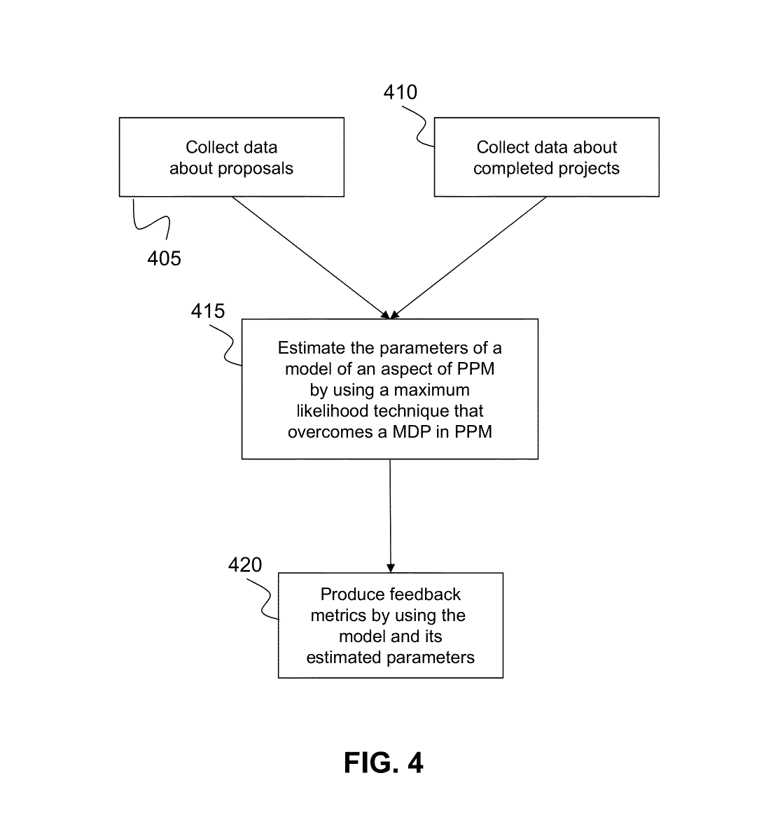

FIG. 4 illustrates the procedure for producing a feedback metric(s) by modeling some aspect of PPM. The first two steps collect data from an appropriate PPM implementation(s). Step 405, the invention collects data about a plurality of proposals, such as the evaluations produced in step 115 of FIG. 1. The specific data collected from the proposals depends on the feedback metric that is being calculated. Once the data is collected, it is input into the computer that performs the calculations of step 415. Step 410 collects data about a plurality of completed projects, such as the results of completed projects. The specific data collected from the completed projects depends upon the feedback metric that is being calculated. Once the data is collected, it is input into the computer which performs the calculations of step 415. Steps 405 and 410 can be performed in any order. They can even be performed simultaneously. For example, the act of inputting the collected data into the computer can occur simultaneously if the collected data were placed in an electronic file and the computer read the file.

At least some of some of the data collected in steps 405 and 410 must pertain to the same projects. Considering a single project, step 405 collects data about a project when it was a proposal. Step 410 collects data about the same project when it was a completed project. Such data is referred to as before-and-after data about a project. Steps 405 and 410 must collect before-and-after data for a plurality of projects.

Notice that it is impossible to obtain before-and-after data for all of the proposals that were evaluated in an implementation. This is because some proposals were not implemented, so these proposals do not become completed projects. Additionally, PPM does not select proposals randomly. Rather it tries to select the best proposals. These two qualities create the MDP in PPM.

Recall that some aspect of PPM is being modeled. Step 415 estimates the parameters of the model. Estimating the parameters is problematic because of the MDP in PPM. Step 415 estimates the parameters by using a maximum likelihood technique that overcomes the MDP in PPM. The maximum likelihood technique calculates the values of the model's parameters that maximize the likelihood that the data collected in steps 405 and 410 would be produced by the model. This is called fitting the model to the data, and identifying the value of the model's parameters is called estimating the model's parameters. Maximum likelihood techniques use algorithms that are computationally intensive, so step 415 must be performed by a computer. This is why steps 405 and 410 input data into the computer that performs step 415. (One can learn more about maximum likelihood techniques by reading about statistical methods for working with missing data. The aforementioned book, Statistical Analysis with Missing Data, by R. Little and D. Rubin, provides a good introduction.

Step 420 produces a feedback metric(s) by using one or more of the parameters that were estimated in step 415. In some cases, an estimated parameter is a feedback metric. In these cases, step 420 merely displays the parameter. In other cases, step 420 uses the fitted model (the model and the estimated parameters) to generate data. The data is then presented in a graph, chart or table, which constitutes the feedback metric. Still other times, step 420 can place the parameters that were estimated in step 415 into software or into a computer file that is used by software. The software can be PPM software, a spreadsheet, the software that is running the current invention, software that helps an organization manage its processes or other software. This software may contain equations that use the parameters. For example, PPM software can contain equations that describe qualities of proposals and portfolios. By placing the estimated parameters into the PPM software, the software's equations use objective data (based on past PPM implementations) rather than peoples' subjective estimates. These methods of using the fitted model are referred to as producing a feedback metric. In each case, the metric is produced by using at least one of the parameters that was estimated in step 415. The illustrated embodiment (presented below) illustrates all of these methods of producing a feedback metric.

In sum, steps 405 and 410 collect data about a PPM implementation(s), with the collected data including before-and-after data for a plurality of projects. Step 415 takes a model of some aspect of PPM and estimates the model's parameters by using a maximum likelihood technique to fit the model to the collected data. The maximum likelihood technique overcomes the MDP in PPM. Step 420 then produces a feedback metric by using at least one of the estimated parameters.

As an illustration of how the described embodiments are not to be understood as limiting the invention, reference is made to the data that is collected in steps 405 and 410 of FIG. 4. When describing these steps, this description states that data is gathered about every proposal and every completed project. However, the method does not require data from every proposal or every completed project. Generally, using more data produces more precise feedback metrics, but the method works if data is gathered for only a portion of the proposals and completed projects.

Embodiments in accordance with the invention produce a feedback metric(s) by modeling some aspect of PPM. The illustrated embodiment produces several feedback metrics by modeling project selection with Bayes' law and Signal Detection Theory, which is a new approach to modeling project selection. The model relates project selection to the results of the completed projects. Therefore, before presenting the embodiment, the new model is presented.

Modeling Project Selection with Bayes' Law and Signal Detection Theory

As will be appreciated from the below description, the illustrated embodiment produces a plurality of feedback metrics. It produces these metrics by modeling project selection with Bayes' law and signal detection theory (SDT), and thereby relating project selection to the results of the completed projects. In order to fully appreciate the illustrated embodiment, a brief discussion is provided.

SDT is a model of classification that is common in psychology, computer science, medicine and electrical engineering. PPM experts will understand SDT after reviewing introductory books, such as D. McNicol's A Primer of Signal Detection Theory (2005, Mahway, N.J.: Lawrence Erlbaum Associates) and N. Macmillan's and C Creelman's Detection Theory, a User's Guide (2005, 2^{nd} edition, Mahway, N.J.: Lawrence Erlbaum Associates). Sophisticated presentations of SDT can introduce the field as well. One such presentation is D. Green's and J. Swet's Signal Detection Theory and Psychophysics (1966, New York: Wiley).

Additionally, PPM experts will understand how to model project selection with Bayes' law and SDT by referencing papers by G. Summers, including “A New Model of PPM,” “Improving PPM with Feedback,” and “Evaluating PPM with Detection Theory.” These papers are available from the author, who can be contacted from his website at StarDecision.com. Additionally, the paper titled “A New Model of PPM” can be viewed on the Internet at maxwideman.com/guests/new_model/intro.htm.

As a brief introduction, the SDT model of PPM classifies completed projects as either Good projects or Bad projects. An organization using this embodiment can define the Good and the Bad categories in any way that suits its needs. For example, suppose a pharmaceutical company wishes to assess its ability to predict success in phase 1 clinical trials. Then Good projects are projects that succeed in phase 1. Bad projects are projects that fail in phase 1. As another example, the IT division of a large company may define Good projects as projects that make exceptional contributions to the company and Bad projects as projects that make average contributions, or worse. The classification of Good and Bad completed projects extends to proposals. Proposals come in two types. A Good proposal is defined as a proposal that, if it is implemented, produces a Good project. Likewise, a Bad proposal is a proposal that, if it is implemented, produces a Bad project.

With these definitions, applying the odds version of Bayes' law to PPM produces the following relationship:

$$\frac{{P}_{Proposals}}{1 - {P}_{Proposals}} * Q P S = \frac{{P}_{Results}}{1 - {P}_{Results}}$$

In this equation P_{Proposals} is the fraction of proposals that are Good proposals, P_{Results} is the fraction of completed projects that are Good projects and QPS is the quality of project selection.

To understand the odds version of Bayes' law, consider its three variables. First, the higher the value of P_{Results}, the better the performance of the portfolio. The reason being when P_{Results} is high the portfolio has more Good projects that create value and less Bad projects that waste resources.

Now consider P_{Proposals}. This variable measures the quality of the proposals from which PPM creates a portfolio. To consider the impact of P_{Proposals} on PPM, suppose you have fifty proposals to choose from. If only five of them are Good proposals (P_{Proposals}=10%), creating a successful portfolio is difficult. If forty-five of them are Good proposals (P_{Proposals}=90%) creating a good portfolio is easy. Even random project selection creates a good portfolio. Clearly, the quality of the proposals affects the difficulty of project selection and the value created by a portfolio.

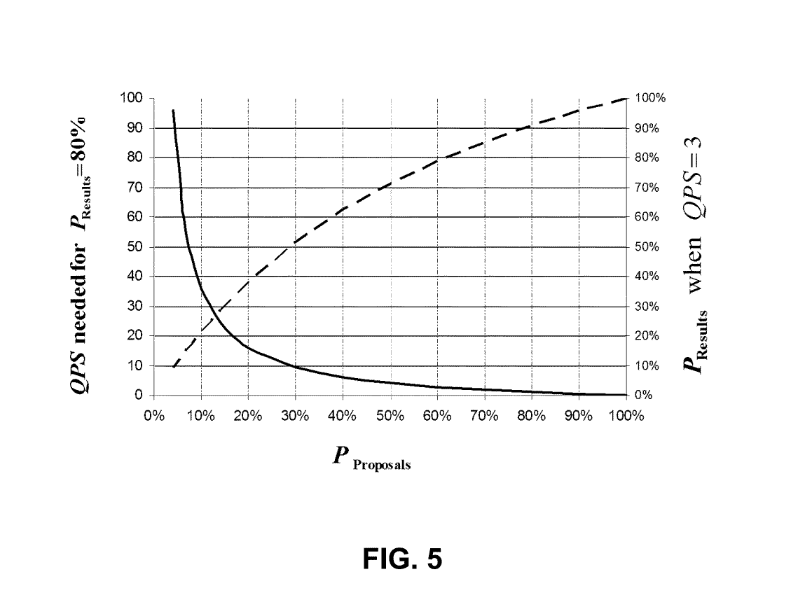

FIG. 5 illustrates these relationships. The horizontal axis shows P_{Proposals}, and the vertical axis on the left shows the QPS needed to produce P_{Results}=80%. The solid curve shows the relationship. When P_{Proposals} is small, achieving P_{Results}=80% requires a tremendously high value of QPS, which is difficult for a company to achieve. When P_{Proposals}>40% the goal becomes attainable with reasonable values of QPS, and as P_{Proposals} increases further, the goal becomes easily attainable. Meanwhile, the vertical axis on the right shows P_{Results}. Using this axis, the dashed curve shows how P_{Proposals} affects P_{Results} when QPS=3 (a realistic value). Increasing P_{Proposals} raises P_{Results}, which raises a portfolio's value.

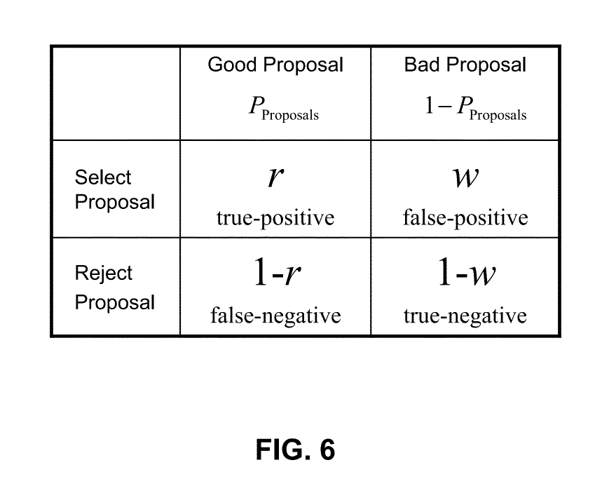

To define the quality of project selection, QPS, some new variables must be defined. These variables are introduced with the aid of FIG. 6. FIG. 6 is similar to FIG. 2 and FIG. 3. Its columns show that there are two types of proposals: Good proposals and Bad proposals. Good proposals occur with a probability (frequency) of P_{Proposals}, and Bad proposals occur with a probability (frequency) of 1−P_{Proposals}. Upon evaluating a proposal, an organization either selects the proposal or rejects the proposal. These choices are represented by the table's rows. Like table 2, table 6 shows the four types of outcomes: true-positive, false-positive, true-negative and false-negative. Additionally, table 6 shows the probabilities of these outcomes occurring. Specifically, table 6 shows four conditional probabilities that describe the outcomes of the decision to select or reject a proposal. These conditional probabilities are:
r=p(Select|Good): The probability of selecting a proposal, given that it is a Good one.
1r=p(Cancel|Good): The probability of canceling a proposal, giving that it is a Good one.
w=p(Select|Bad): The probability of selecting a proposal, given that it is a Bad one.
1−w=p(Cancel|Bad): The probability of canceling a proposal, given that it is a Bad one.

One can learn more about these probabilities by reading the aforementioned books on SDT. For example, from the information in table 6 one can calculate the probability of various outcomes. The probability of a true-positive occurring is r*P_{Proposals}.

The conditional probabilities, r and w define the quality of project selection. This is because the conditional probabilities describe an organization's ability to identify Good and Bad proposals. The variable r answers the question, “How likely is an organization to recognize a Good proposal when it sees one?” The variable w answers the question, “How likely is an organization to recognize a Bad proposal when it sees one.” In the odds version of Bayes' law the variables r and w specify the quality of project selection as QPS=r/w.

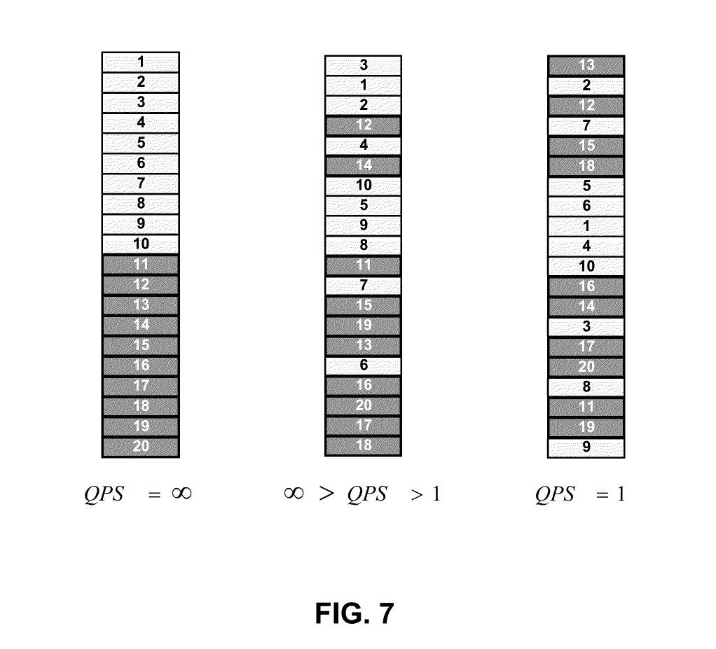

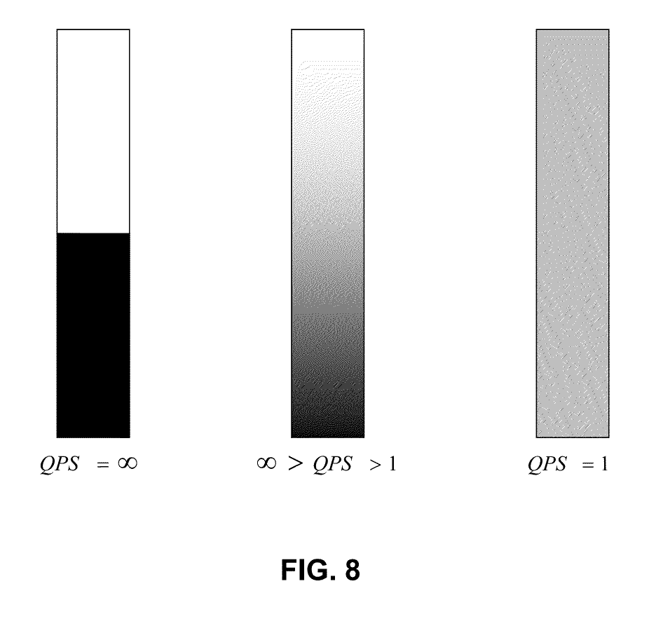

Having defined QPS, we can now see how two qualities of PPM determine the value of QPS. These qualities are uncertainty and the aggressiveness of project selection. FIGS. 7 and 8 illustrate these qualities. FIG. 7 shows a common method of selecting proposals. Proposals are evaluated and ranked. A budget is set, and proposals are chosen by starting at the top of the ranking and selecting down the ranking until the budget is consumed. In FIG. 7 each stack of bars represents a ranking of proposals. A proposal's place in the ranking is shown by its place in the stack. The proposal that is considered to be the best one sits on top of the stack, and the proposal that is considered to be the second best one sits second from the top. The bottom bar represents the proposal with is considered to be the worst one. A bar's number represents a proposal's correct ranking. Furthermore, a bar's shade (light or dark) shows a proposal's type. Light bars represent Good proposals, and dark bars represent Bad proposals.

Consider the prioritization (stack) on the left side of FIG. 7. It shows a perfect ranking. A perfect ranking occurs when there is no uncertainty. When there is no uncertainty the proposal evaluations are errorless and the organization can correctly identify all of the Good proposals and all of the Bad proposals. As a result, it selects every Good proposal and it rejects every Bad proposal. In this situation, r=1, w=0 and QPS=∞. Now consider the prioritization (stack) on the right side of FIG. 7. The prioritization illustrates a random ranking. Uncertainty is pervasive, so the organization has no ability to evaluate proposals. The organization is as likely to select a Good proposal as it is to select a Bad proposal, so r=w and QPS=1. Finally, consider the middle stack of FIG. 7. It shows a realistic case. Uncertainty causes some errors, so r<1, and w>0. However, uncertainty is not pervasive, so the organization has some ability to distinguish Good from Bad proposals. Because of this ability, the organization is more likely to select a Good proposal than a Bad proposal, which implies that r>w. When uncertainty exists but is not pervasive, 1<QPS<∞. By viewing the three prioritizations of FIG. 7, one can see the impact of uncertainty on the quality of project selection. As uncertainty increases, the quality of project selection, QPS, decreases.

The bars of FIG. 8 are analogous to the stacks of FIG. 7. However, instead of showing individual proposals, the bars show the probability that a project is a Good one. The color white represents p(Good)=1 and the color black represents p(Good)=0. Grey represents values in between, with lighter shades implying a greater probability of being a Good proposal. The bar on the left side of FIG. 8 represents a perfect ranking. Good proposals are on top, and Bad proposals are on the bottom. The bar on the right side of FIG. 8 illustrates a random ranking. Good and Bad projects are randomly mixed, producing a uniform shade of grey. (Recall that a fraction of Good proposals is P_{Proposals}. When the ranking is random the probability of a proposal being a Good one is P_{Proposals}, regardless of its location in the ranking.)

The realistic case is illustrated by the middle bar, in which uncertainty exists but is not pervasive. Because of uncertainty, evaluation errors can make a Bad proposal look like a Good one. However, uncertainty is unlikely to make a Bad proposal look fantastic. Likewise, uncertainty can make a Good proposal look bad, but it is unlikely to make a Good proposal look terrible. Generally, the higher a proposal is in the ranking, the more likely it is to be a Good proposal. The lower a proposal's position in the ranking, the more likely it is to be a Bad proposal. For the realistic case, the bar is light at the top but becomes progressively darker as one goes down the ranking. This relationship is true for the project evaluations as well, even if the PPM implementation does not explicitly rank proposals. The higher a proposal's evaluation (score), the more likely it is to be a Good proposal. The lower a proposal's evaluation (score), the more likely it is to be a Bad proposal.

The pattern illustrated by the middle bar implies that if an organization selects only the proposals that have the highest evaluations, the organization is likely to select Good proposals and unlikely to select Bad proposals. This approach to selection is called cautious selection. Cautious selection produces a high value of QPS. Suppose an organization that initially selects cautiously abandons its caution and selects deep into its ranking. Its portfolio becomes bigger, because it is selecting more proposals. Whether a proposal is Good or Bad, it is more likely to be selected, so both r and w increase. However, because the probability of a proposal being a Good one decreases as the organization selects deeper into the ranking, w increases faster than r. As a result, QPS, decreases. Selecting deep into a ranking is called aggressive selection. As selection becomes more cautions (selecting fewer proposals), QPS increases. As selection becomes more aggressive (selecting more proposals), QPS decreases.

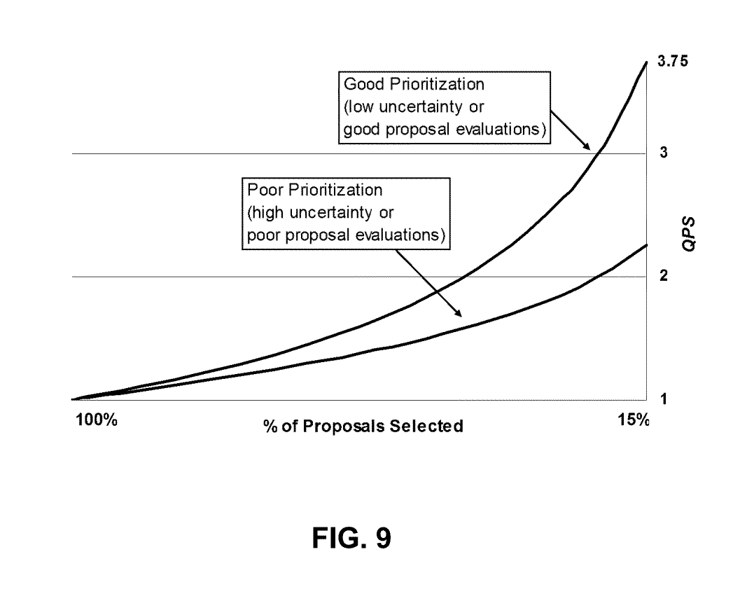

The curves in FIG. 9 are called prioritization curves, and they show the impact on QPS of both uncertainty and the aggressiveness of selection. With reference to either curve (for example, the lower curve), one can see the impact of the aggressiveness of selection. If an organization selects 100% of the proposals, P_{Proposals}=P_{Results}. As a result, QPS=1 (see Bayes' law). If an organization selects fewer proposals, QPS increases.

Together the two curves show the impact of uncertainty. When uncertainty is high, prioritization is poor and QPS is poor. The lower curve represents this situation. When uncertainty is low, prioritization improves and QPS is increased. The higher curve represents this situation. By comparing the curves, one sees that for all levels of aggressive or cautious selection, except for funding all proposals, having less uncertainty produces a higher value of QPS. As the figure notes, the quality of the proposal evaluations has the same effect as uncertainty. Better evaluations shift the curve upward, while worse evaluations shift the curve downward.

FIGS. 7, 8 and 9 describe the relationship between uncertainty, selection and QPS. We need a model that enables us to estimate P_{Proposals} and QPS for various levels of selection (most aggressive to cautious), and SDT fulfills this need.

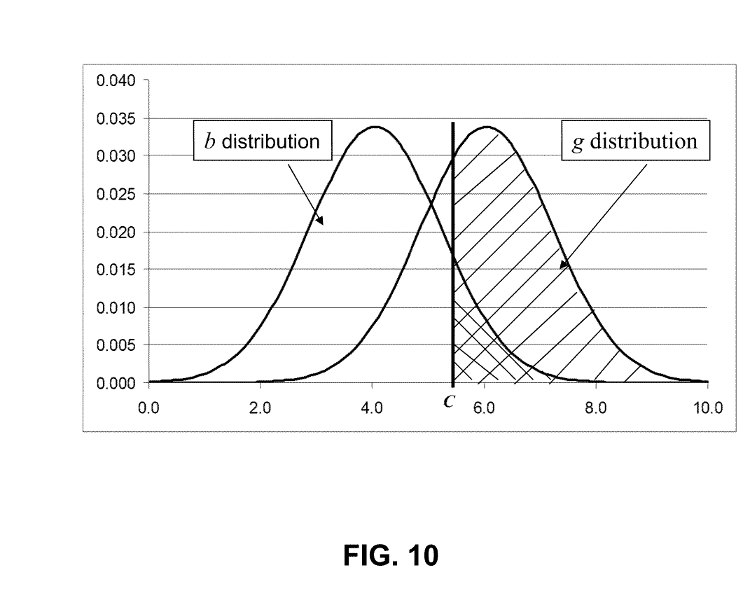

FIG. 10 illustrates the SDT model. In this illustration, proposals are evaluated with a scoring model. Proposals' scores can range between zero and ten. The scores, s, of proposals are distributed according to the following functions. The function b(s|Bad) is the density function of a proposal's score being s, given that the proposal is a Bad one. For convenience I sometimes refer to this function as b. The function b describes the distribution of the scores of Bad projects. The function g(s|Good) is the density function of a proposal's score being s, given that the proposal is a Good one. For convenience I sometimes refer to this function as g. The function g describes the distribution of the scores of Good projects. In SDT, the functions b and g are normal distributions: g˜N(μ_{g}, σ²) and b˜N(μ_{b}, σ²), where μ_{g} and μ_{b} are the means of the distributions and σ² is the variance of the distributions. Notice that the functions have difference means, but they have the same variances. In SDT the variances can differ, but making them the same simplifies the model, and this simplified model can be used in the illustrated embodiment. FIG. 10 illustrates the distributions. The “b distribution,” shows b, and the “g distribution” shows g. As the figure illustrates, in SDT μ_{g}>μ_{b}, so that proposals with higher scores are more likely to be Good proposals. Notice that the distributions overlap. Because the distributions overlap, selecting proposals difficult. A Bad proposal can have a higher score than a Good proposal.

The solid line in FIG. 10 is a cutoff value, C. A cutoff value is a common technique for selecting proposals. The method is equivalent to selecting projects with a hurdle rate or to funding down a ranking until a budget is exhausted. When selecting projects with a cutoff value, all projects with scores greater than or equal to the cutoff value, C, are selected. All projects with scores less than C are rejected. Increasing the value of C makes project selection more cautious, and lowering C makes project selection more aggressive.

The probability of selecting a proposal depends upon C. Specifically, the probability of selecting a proposal, given that the proposal is a Good one, is the area under g that is to the left of the cutoff value. In FIG. 10 this is the area in g that has the diagonal lines running from south-west to north-east. Meanwhile, the probability of selecting a proposal, given that the proposal is a Bad one, is the area under b that is to the left of the cutoff value. In FIG. 10 this is the area in b that has the diagonal lines running from south-east to north-west. Since the probability of selecting a Good or a Bad proposal is the area under a curve and to the left of the cutoff value, we can specify r and w. Specifically,

$$r = {{\int }_{s = C}}^{∞} g ( s \vert Good ) d s and w = {{\int }_{s = C}}^{∞} b ( s \vert Bad ) d s .$$

For a nice illustration of these relationships, see Mathat Gönen's book, Analyzing Receiver Operating Characteristics Curves with SAS, especially pages 20-21 and 26-27. Having presented the Bayes' law and SDT model of PPM, the illustrated embodiment is presented next.

### AN ILLUSTRATED EMBODIMENT

PPM is often performed by classifying projects into categories, called strategic buckets. PPM typically then proceeds by selecting projects from each bucket. This embodiment is best applied to a strategic bucket in a PPM implementation(s). For a strategic bucket, the embodiment produces multiple feedback metrics by modeling project selection for the bucket. If desired, the embodiment can be applied to each strategic bucket in a PPM implementation(s).

The PPM implementations that can be evaluated by this embodiment, the appropriate implementations, preferably have three qualities. The first quality is that the PPM implementation must evaluate proposals on an interval or a ratio scale. For example, the evaluations of the proposals can be financial metrics, expected values (such as the values produced by decision trees or decision analysis), values produced by the analytic hierarchy process or values produced by a scoring model. It is noted that if several implementations use the same technique for evaluating proposals, the method can collect data from each implementation. For sake of illustration, the illustrated embodiment assumes that proposals are evaluated with a scoring model, with possible scores ranging from zero to ten.

The second quality of an appropriate implementation comes from the way PPM selects proposals. PPM tends to select proposals with the highest evaluations, but there are usually exceptions. Exceptions occur when executives reject a few proposals that have high evaluations or select a few proposals that have low evaluations. Typically, this embodiment works if there are limited exceptions. Preferably, but not limited thereto, the number of selected proposals with low evaluations should be limited to approximately ten percent of the total number of selected proposals.

To more precisely illustrate the implementations that are appropriate for this embodiment, consider the following method of selecting proposals. Each proposal is evaluated with a scoring model using a software program in accordance with one embodiment of the invention. Executives set a cutoff value such as by entering such value into the software program, and proposals with scores equal to or above the cutoff value are selected by the program. Proposals with scores below the cutoff value are rejected by the program. Subsequently, executives make exceptions by selecting some proposals with scores that are below the cutoff value, such as by overriding the foregoing default program selections. Simulations studies suggest that the illustrated embodiment can be used when the exceptions (selected proposals that have scores below the cutoff value) comprise up to ten percent of the selected proposals. It is noted that the present illustrated embodiment can also work when more exceptions exist, but these situations have not yet been tested.

The third quality of an appropriate implementation is the amount of data that is needed by this embodiment. The embodiment, using the algorithms applied to the processor of the machine executing the software, estimates g and b, and it uses these estimates to create feedback metrics. To produce precise estimates this embodiment needs before-and-after data from at least thirty-five completed projects entered in the software program. Additionally, the embodiment requires data from at least fifteen rejected proposals entered in the software program. If needed, an organization can use data from several PPM implementations. For example, if an organization has data from the past two years, a strategic bucket must average twenty-five proposals and eighteen completed projects per year. If data from the past three years is available and relevant, the strategic bucket must average seventeen proposals and twelve completed projects per year. These data requirements were preferably estimated by simulation studies. It is to be appreciated that this embodiment can execute with less data, but such situations have not yet been studied.

There is an exception to these data requirements. One of the feedback metrics produced by this embodiment is P_{Proposals}. This feedback metric can be estimated with less data than described above, although the lower limit has not yet been identified. If an organization wished to estimate P_{Proposals}, which evaluates step 110 of FIG. 1 (see forthcoming description), it can use less data than is recommended above.

With reference to the embodiment illustrated in FIG. 4, using software in accordance with the embodiment, an evaluation of PPM implementation(s) starts at step 405. This step enters the scores of all of the proposals that were evaluated in the PPM implementation(s) into the software program—both the selected proposals and the rejected proposals. Step 405 also enters into the software program the status of the proposals: selected or rejected.

This data is generated by the software program when PPM is performed, at step 115 of FIG. 1. If an organization uses PPM software, the proposal's scores and status is recorded by the PPM software. Alternatively, an organization can record the values in a spreadsheet, in a database or even with old fashion paper. Step 405 collects this data (proposal's scores and status) and inputs it into the computer that performs from the calculations in step 415. The data can be input electronically or by hand.

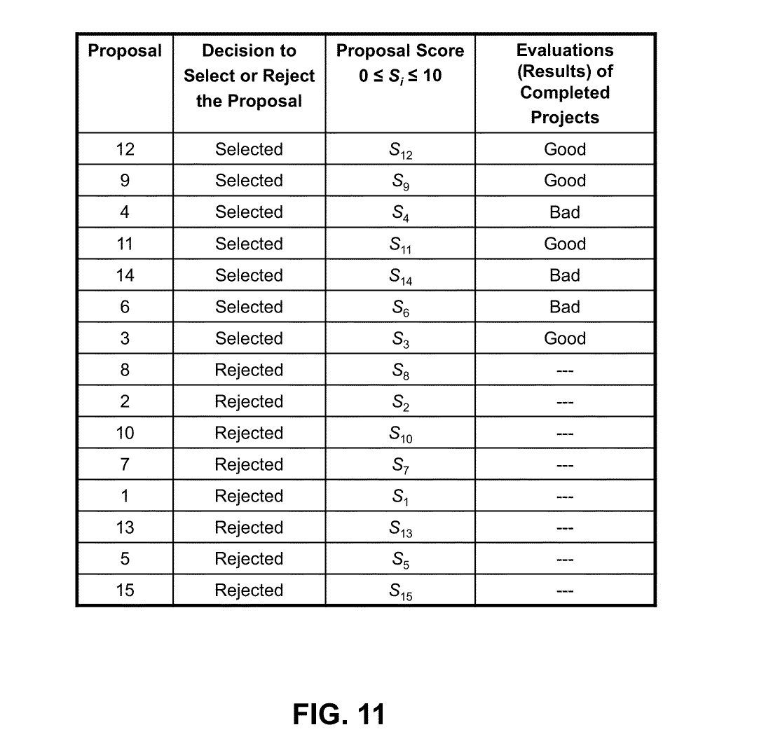

FIG. 11 illustrates the data that is collected in step 405 as a table having four columns. Column 1 lists the proposals that were evaluated in the PPM implementation(s). For the purpose of illustration, each proposal is identified with a number, although most organizations use a more sophisticated method of identifying proposals. Column 2 shows whether the proposal was selected or rejected. Column 3 shows the score of each proposal—both the selected and the rejected proposals. Notice that the selected proposals are at the top of the list. The table lists the proposals in order of their scores. Proposal 12 has the highest score and proposal 15 has the lowest score.

In the PPM implementation(s), the selected proposals were executed (step 135 of FIG. 1), and these proposals are subsequently referred to as completed projects. At step 410 the present embodiment collects results from the completed projects and enters these results into the software program that performs the calculations in step 415. For this embodiment, the results are whether each completed project was a Good project or a Bad project, with Good and Bad defined as previously described.

It is noted this data may already exist if the organization evaluated the completed projects at step 145 of FIG. 1. For instance, the organization may have stored the results in PPM software, a spreadsheet, a database or wherever the organization stores its PPM data. In this case, step 410 enters this data into the software program performing the calculations of step 415. However, an organization may not have evaluated the completed projects (many organizations skip step 145 of FIG. 1) or the organization's evaluations may not have classified the completed projects as Good or Bad. In these cases, the current embodiment requires that step 410 enters in the software program the data by defining the Good and Bad categories and classifying each completed project as either a Good project or a Bad project. Whether the classifications were made at step 145 or when the embodiment is being executed, this part of step 410 is called collecting the data. The collected data is entered into the software program that performs the calculations in step 415. The data can be entered electronically or manually. FIG. 11 illustrates the data that is collected in step 410. This data is displayed in column 4 of the table.

Table 11 illustrates three qualities of the data that is collected in steps 405 and 410. First, the rejected proposals do not have any results. Second, the selected proposals were not selected randomly. They are the proposals with the highest scores. These first two qualities illustrate the MPD in PPM. Third, steps 405 and 410 record before-and-after data for a plurality of projects. This third quality is utilized by embodiments of the invention to provide feedback.

The parameters of the SDT model are P_{Proposals}, μ_{g}, μ_{b} and σ², and by estimating these parameters the software program of embodiment can derive numerous feedback metrics. If not for the missing data problem, estimating these parameters would typically be straightforward and simple. Unfortunately, the MDP in PPM exists, as illustrated by FIG. 11, so the software of embodiment is preferably programmed to use a technique that overcomes the MDP problem.

The software program in step 415 overcomes the MDP in PPM by preferably using a maximum likelihood technique. This technique estimates the values of P_{Proposals}, μ_{g}, P_{b} and σ² that maximize the likelihood that the data collected in step 405 and 410 would be produced by the SDT model. In other words, the maximum likelihood technique as executed by the software program addresses the following question, “What values of P_{Proposals}, μ_{g}, μ_{b} and σ² maximize the likelihood of the SDT model producing the data that was collected in steps 405 and 410?” The process performed by the software program for answering this question is called fitting the SDT model to the data or estimating the parameters of the model.

The question is answered (or equivalently, the parameters of the model are estimated) by creating a formula in the software program that gives the likelihood of the data occurring. To create this formula, the density function of the proposal scores is p(s)=f₁ (s; θ₁)π+f₀ (s; θ₀)(1−π), where π=P_{Proposals}, f₁ (s; θ₁)=g and f₀ (S; θ₀)=b. The θ₀ and θ₁ are vectors of the unknown parameters in each distribution: μ_{g} and σ² for f₁ and μ_{b} and σ² for f₀.

From this formula one can calculate the likelihood of the SDT model producing each proposal's score that was recorded in step 405. Let i be an index over the proposals and let k={0, 1} represent the two types of proposals, with the number 1 representing Good proposals and the number 0 representing Bad proposals. Because of the information collected in step 410, the type of proposal is known (Good or Bad) for every selected proposal. For instance, if proposal i was selected, the likelihood of its score, sᵢ, occurring is L₁=πₖfₖ(s₁; θₖ), where k indicates the proposal's type. For the rejected proposals, step 405 recorded their scores, but their types (Good or Bad) are unknown. If proposal i was rejected, the likelihood of its score occurring is L₁=Σₖ₌₀¹πₖfₖ(sᵢ; θₖ).

The above formulas give the likelihood for each score that was collected in step 405 through processing in the software program. With these formulas one can present a formula for the likelihood of the entire set of data. To specify this formula, the software is preferably programmed to index the proposals so the first m proposals are rejected and the remaining n proposals are selected. Additionally, the software program defines Ψ=(π′, θ′)′ as a vector of all the unknown parameters. Then the likelihood of the observing the proposal scores (the data in column 3 of FIG. 11) is giving by a function called the likelihood function. The likelihood function is

$${L}_{obs} ( Ψ ) = {\prod }_{i = 1}^{m} \{ {\sum }_{k = 0}^{1} {π}_{k} {f}_{k} ( {s}_{i} ; {θ}_{k} ) \} {\prod }_{i = m + 1}^{m + n} \{ {\sum }_{k = 0}^{1} {z}_{ik} {π}_{k} {f}_{k} ( {s}_{i} ; {θ}_{k} ) \} ,$$

where zᵢₖ equals one if project i is from class k and zero otherwise.

For the software program to fit the model to the data, step 415 must find the values of Ψ that maximize the likelihood function, L_{obs} (Ω). Maximizing this function is particularly difficult because of the multiplications in the formula. One way to turn the multiplications into summations in the software program is by taking the logarithm of the likelihood function, log L_{obs}, which is called the log likelihood function. The log likelihood function is

$$log {L}_{obs} = {\sum }_{i = 1}^{m} log \{ {\sum }_{k = 0}^{1} {π}_{k} {f}_{k} ( {s}_{i} ; {θ}_{k} ) \} + {\sum }_{i = m + 1}^{m + n} {\sum }_{k = 0}^{1} {z}_{ik} log ( {π}_{k} {f}_{k} ( {s}_{i} ; {θ}_{k} ) ) .$$

It is to be appreciated that the likelihood function and the log likelihood function are maximized at the same values of the parameters (P_{Proposals}, μ_{g}, μ_{b} and σ²), so the software program in step 415 can estimate the values of the parameters by maximizing the log likelihood function. The technique used to find these values is called the EM algorithm. The EM algorithm works by iteratively adjusting the parameters, a bit at a time, until it finds the values that maximize the log likelihood function.

Fitting the SDT model to the data collected in the software program in steps 405 and 410 is an example of a technique that is called fitting a mixture model with partially classified data. It is to be appreciated that numerous sources describe this technique. For instance, these sources include McLachlan's Discriminant Analysis and Statistical Pattern Recognition (2004, Wiley-Interscience) and McLachlan's and Peel's Finite Mixture Models (2000, Wiley-Interscience), each hereby incorporated by reference for its teachings thereto. Furthermore, examples for applying the technique are provided by several scholarly papers including G. J. McLachlan, and P. N. Jones (1988), “Fitting mixture models to grouped and truncated data via the EM algorithm,” Biometrics, 44(2): 571-578; G. J. McLachlan and R. D. Gordon (1989), “Mixture models for partially unclassified data: a case study of renal venous rennin levels in essential hypertension,” Statistics in Medicine, 8(10): 1291-1300; and A. J. Feelders, (2000), “Credit scoring and reject inference with mixture models,” International Journal of Intelligent Systems in Accounting, Finance & Management, 9: 1-8, all of which are also hereby incorporated by reference for its teachings thereto.

It is noted that PPM practitioners and scholars may desire to write their own software that implements the EM algorithm to find the values of the parameters (P_{Proposals}, μ_{g}, μ_{b} and σ²) that fit the SDT model to the collected data. These practitioners can learn about the EM algorithm from numerous sources. These sources include R. Little and D. Rubin's book Statistical Analysis with Missing Data, 2^{nd} edition, (2002, New York: Wiley) and McLachlan's and Krishnan's book The EM Algorithm and Extensions (2008, Wiley), each hereby incorporated by reference for its teachings thereto.

It is to be appreciated that programming the EM algorithm requires sufficient mathematical skill and fortunately there exists a computer program that uses the EM algorithm to fit mixture models with partially classified data. This computer program is called EMMIX, and it can be used to fit the SDT model to the collected data. For instance, to estimate the values of P_{Proposals}, μ_{g}, μ_{b}, μ_{b} and σ² with EMMIX, steps 405 and 410 collect data and place the data into an appropriately organized software text file. Step 415 runs the EMMIX program in the software program of the embodiment of the invention, and EMMIX reads the text file, fits the SDT model to the data and outputs the estimated values of P_{Proposals}, μ_{g}, μ_{b} and σ² into another software text file. The manual for EMMIX, which is hereby incorporated by reference, describes the input and output text files and the operation of the EMMIX program. The EMMIX software and manual are available via the Internet at maths.uq.edu.au/˜gjm/emmix/emmix.html.

The process of fitting the SDT model to the collected data in the software program produces an accurate and precise estimate of P_{Proposals}. The estimate of P_{Proposals} is a feedback metric (see below), so fitting the SDT model produces a feedback metric. Unfortunately, the estimates of μ_{g}, μ_{b} and μ² lack precision. The imprecision occurs because the SDT model assumes that the distribution of Good proposal scores and distribution of Bad proposal scores are both normal distributions (as illustrated in FIG. 10). However, PPM need not fit these assumptions. In PPM, the distributions of proposal scores may not be normal curves.

This problem is overcome in the software program in accordance with one embodiment of the invention, thereby increasing the precision of the estimates by transforming the scale on which the proposals are evaluated. This transformation works so long as the transformation maintains the rank order of the proposals. The ability to improve the fit of the model via such transformations is a consequence of SDT, which measures the ability to classify proposals as Good or Bad. When determining the quality of the classifications, the ranking of the proposals is important, but the actual values of the evaluations are not important. To learn more about this quality of SDT, see Macmillan's and Creelman's Detection Theory: a User's Guide and M. Gönen's Analyzing Receiver Operating Characteristic Curves with SAS (2007; Cary, N.C.: SAS Publishing), both of which are hereby incorporated by reference.

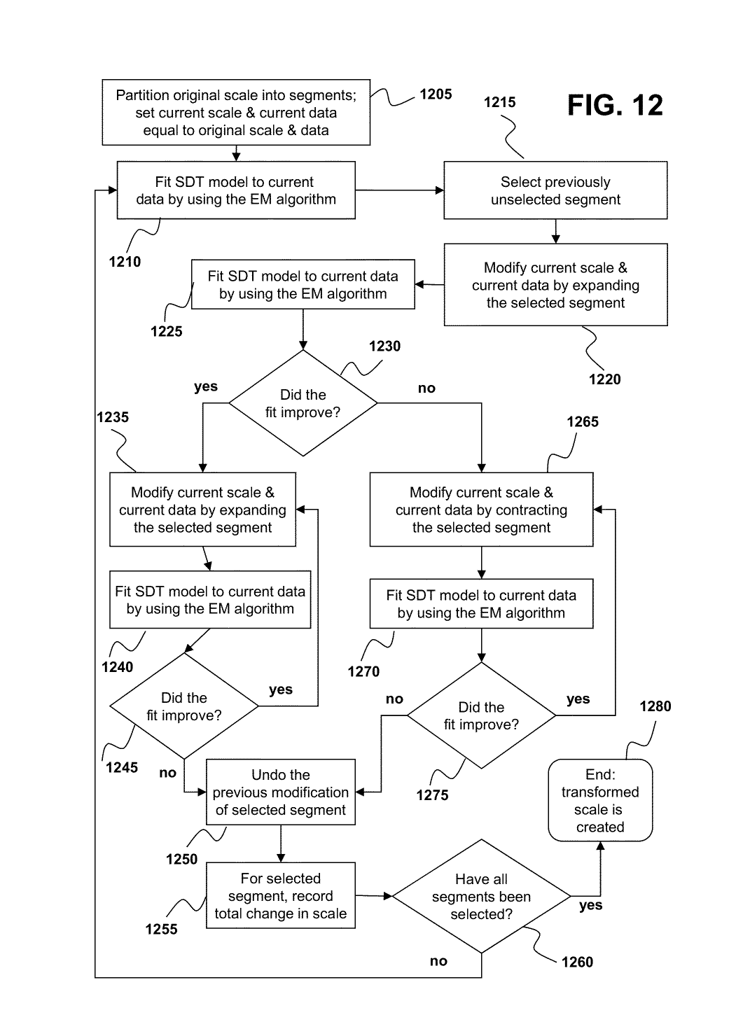

FIG. 12 illustrates a procedure performed in the software program for transforming the scale of the evaluations while fitting the SDT model to the data.

The process starts with step 1205, where the original scale for evaluating proposals is partitioned into segments. For example, if proposals are scored on a scale ranging from zero to ten, one can partition the scale into ten segments: 0 to 1, 1 to 2, 2 to 3, etc. Additionally, step 1205 sets the current scale equal to the original scale, and it sets the current data equal to the original data (the data collected by steps 405 and 410).

Step 1210 fits the SDT model to the current data by using the EM algorithm in the software program to estimate the values of the parameters (P_{Proposals}, μ_{g}, μ_{b} and σ²) that maximize the likelihood of the data, as described above. As noted, this procedure is referred to as fitting the SDT model.

Step 1215 preferably selects a previously unselected segment (on the first pass none of the segments have been selected).

Step 1220 modifies the current scale in the software program (but not the original scale or the original data), which modification makes three changes. First, the selected segment is expanded with a linear transformation. Second, the segments of scale and that were “above” the selected segment (have values greater than the values in the original segment) are shifted upward. This modified scale becomes the new current scale. Third, the proposal scores that were “above” the selected segment are shifted upward. For the scores that are shifted, the current scores include these new scores in place of the previous ones. In total, this type of modification (1) expands the scale within the chosen segment and (2) preserves the ranking of the proposals. The second quality means that the rank order of the proposals remains unchanged.

This modification step is illustrated with the aforementioned ten point scale. For instance, suppose the segment 3 to 4 was selected at step 1215. The first change of the modification process in the software program uniformly increases the size of the segment to range from 3 to 4.5 (expanding the scale). In the second change, the segments that were above the 3 to 4 are shifted upward 0.5 units. The scale now ranges from 0 to 10.5. In the third change, the proposal scores with values greater than 4 are increased 0.5 units. For example, a score of 4.75 is increased to 5.25. After this transformation by the software program, the current scale is set to the modified scale (0 to 10.5), and modified scores current data are included in the current data.

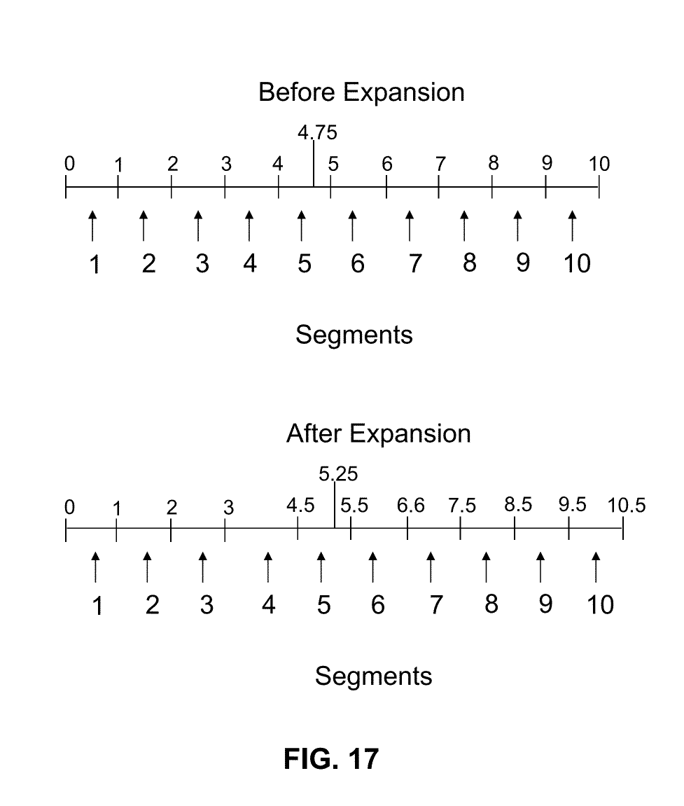

FIG. 17 illustrates this example. The scale on the top is the scale before the modification. The scale on the bottom is the scale after the modification. For each scale, the ten segments are identified by the numbers and arrows that are below the scale. On the top scale, the scale ranges from 0 to 10, and there is a proposal with a score of 4.75. As the bottom scale indicates, the modification expanded the forth segment from 3 to 4 to a larger size of 3 to 4.5. Meanwhile, the fifth through tenth segments were shifted up by an amount of 0.5 units. The project score was shifted up 0.5 units to a value of 5.25. Notice that the first, second and third segments remained unchanged.

After the software program modifies the scale, the software program at step 1225 fits the SDT model to the current data. Then at step 1230 the software program compares the fits from steps 1210 and 1225 to determine if the modification improved the fit. The fit improved if the likelihood of the data is increased. (The concept that increasing the likelihood of the data improves the fit was introduced above and is further described in the aforementioned references on missing data problems and the EM algorithm.)

If the fit improved, the process of the software program proceeds to step 1235. The software program at step 1235 modifies the current scale by expanding the selected segment again, thereby creating a new current scale and new current data (as previously described). Then at step 1240 the software program fits the SDT model to the current data, and at step 1245 checks to determine if the fit improved. The aforesaid cycle continues until an expansion of the scale does not improve the fit, in which case the expansion degrades the fit.

When the fit degrades, the process in the software program moves to step 1250, where the previous modification of the scale and data are reversed. This step changes the current scale and current data back the state that existed before the previous (harmful) modification. Then at step 1255 the software program records the total change in the scale for the selected segment.

Subsequently, at step 1260 the software program checks to see if any of the segments have not yet been selected. If at least one segment remains to be selected, the process loops to step 1210. If all of the segments have been selected, the process moves from step 1260 to step 1280. When the process of the software program arrives at step 1280, all of the segments have been modified in ways (expanded or contracted) that improve the fit of the model, and all of the modifications have been recorded. At step 1280, the process ends.

If at step 1230 the software program determines the fit did not improve, the process moves to step 1265. At step 1265 the software program modifies the scale by performing a linear transformation that contracts the scale within the selected segment. Using the previous example, the segment of the scale from 3 to 4 can be shrunk with a linear transformation. As a result, this segment can range from 3 to 3.75. After this transformation by the software program, all of the segments with higher values than the selected segment must be shifted down by 0.25 units. Likewise, all of the proposal scores that are greater than the highest value of the selected segment must be shifted down by 0.25 units. A proposal with a score of 4.75 has its score shifted down to 4.5. This type of change (1) compresses the scale within the selected segment while (2) preserving the rank order of the proposals. As previously described, the modification of the scale by the software program creates a new current scale and current data.

After the contraction of the scale by the software program, step 1270 fits the SDT model to the current data, and step 1275 determines if the contraction improved the fit. If the fit improved, the process loops to step 1265. Otherwise, the process continues with step 1250, where it progresses as previously described. The steps 1265, 1270 and 1275 operate like steps 1235, 1240 and 1245, with one exception, step 1265 contracts, rather than expands the selected segment.

When this process is completed by the software program, the new scale and set of scores are called the transformed scale and the transformed scores. The transformation produced by the software program has adjusted the scores of the proposals so that the distribution of scores is more like that produced by two normal distributions. However, the transformation leaves the order (ranking) of the proposals unchanged. Furthermore, because the process records the modification of each segment of the scale, the embodiment can select any score from the original scale and calculate its value on the transformed scale. Likewise, the embodiment can select any value on the transformed scale and calculate its value on the original scale.

After step 415 has finished, the software program of the current embodiment has estimated P_{Proposals}, and for the transformed scale, it has produced estimates of μ_{g}, μ_{b} and σ². As a result, it has estimated g˜N(μ_{g}, σ) and b˜N(μ_{b}, σ) on the transformed scale.

At step 420 the software program produces feedback metrics by using the estimates of P_{Proposals}, g and b that were produced by step 415. If needed, step 420 can also use the record of the modifications of the scale. As previously stated, step 420 can produce feedback metrics with at least three methods. First, if one of the estimated parameters is a feedback metric, step 420 can display the estimated parameter. Second, step 420 can use the fitted model to create data and then display that data in a table, chart of graph. Third, at step 420, the software program can place one or more of the estimated parameters, the data produced by fitting the model or a display of this data into a memory storage device of a computer for use by another software program. The third method allows another software program to use the results generated by the aforesaid software program of one embodiment of the invention. It is to be appreciated that the other software program can be PPM software, a spreadsheet, software that is running the illustrated embodiment, or software that helps an organization manage its processes or other software.

Methods for producing a feedback metric are described below.

The estimate of P_{Proposals} indicates the fraction of proposals that are Good proposals. It is an evaluation metric that measures the quality of the proposal process of the PPM implementation(s) (step 110 of FIG. 1). Step 420 of the software program produces this metric by displaying it. It can display the estimate electronically, for example on a display that is connected to the computer executing the software program which performed step 415. Alternatively, step 420 can output the value of P_{Proposals} from a computer in a report or the like. Additionally, the software program can place the estimate in a computer file to be placed in a computer storage device or into another software program, so that the estimate can be used by other software program.

With reference to FIG. 13, a display of P_{Proposals} is illustrated. In this illustration, the software program of the illustrated embodiment is used to evaluate a PPM implementation(s) of a printer company that has three product divisions, namely: office inkjet printers, office laser printers and professional printing. The company's PPM includes a strategic bucket for each division. The software program of the illustrated embodiment is preferably applied once to each strategic bucket in order to estimate P_{Proposals} for each division. In step 420, the software program instructs a computer to display the results in a table, as illustrated by FIG. 13.

Another feedback metric that the software program can produce in step 420 is a prioritization curve. Prioritization curves were previously introduced as illustrated in FIG. 9. Prioritization curves measure the quality of prioritization and thereby evaluate step 120 of FIG. 1. To appreciate how step 420 produces a prioritization curve, it is noted, and as mentioned above, the parameters μ_{g}, μ_{b} and σ², via the software program, fit the distribution g and b to the transformed scale. With these estimates, the software program in step 420 can calculate r and w for any cutoff value on the transformed scale. The calculations use the (previously introduced) equations

$$r = {{\int }_{s = {C}^{′}}}^{∞} g ( s \vert Good ) d s and w = {{\int }_{s = {C}^{′}}}^{∞} b ( s \vert Bad ) d s ,$$

where C′ is a cutoff value on the transformed scale.

Meanwhile, the software program in step 420 can use the values of r and w to calculate the quality of project selection because QPS=r/w. As a result, the software program in step 420 can produce numerous data points (C, QPS) and plot these points on a graph, thereby illustrating the prioritization curve. These graphs are plotted on the transformed scale, so they will have smooth curves, as illustrated in FIG. 9.

Furthermore, recall that the software program in step 415 recorded the modifications that transformed the scale. By using these records, the software program in step 420 can transform the values of C to the original scale to create data points (C, QPS). The software program in step 420 can plot these data points and thereby display the prioritization curves on the original scale for evaluating proposals. Typically, this graph does not have smooth curves.

Whether the software program in step 420 graphs the prioritization curve on the transformed scale or the original scale, it has used the fitted model to create data that it can present in a graph. The software program in step 420 can be instructed to present the graph electronically, perhaps on a display associated with the computer executing the software program. Thus, the software program can instruct the computer to print the graph, perhaps in a report about PPM. Finally, it can place a variety of data into a computer file or into another software program, so that another program can utilize the fitted SDT model. For example, the software program in step 420 can place the following data into a computer file: estimates of μ_{g}, μ_{b}, σ², the record of the segment modifications, the data points (C, QPS) or the graph of the data points.

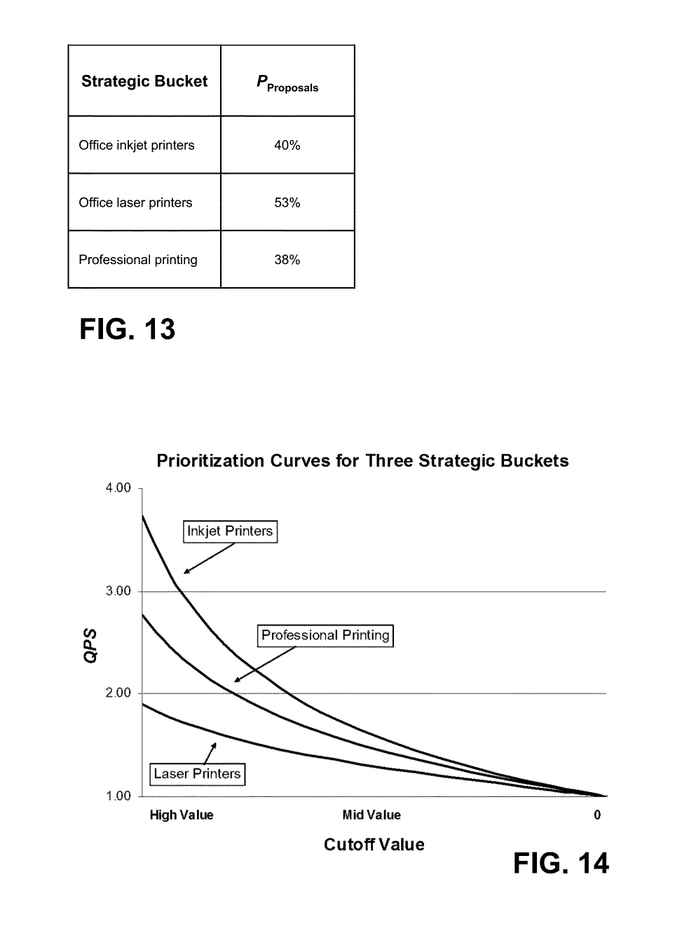

By continuing the example of the printer company, FIG. 14 illustrates prioritization curves. The illustrated embodiment is applied to each strategic bucket to produce a prioritization curve for each bucket. FIG. 14 presents these curves, although the figure is not to be understood as an accurate depiction of the results. The software program in FIG. 14 plots the three prioritization curves on the transformed scale of one of the strategic buckets, so only one of the curves should be smooth. The other two curves should have some non-smooth segments or portions in them. Acknowledging this blemish in the illustration, FIG. 14 shows the possibility of presenting multiple prioritization curves in a single graph.

The software program in step 420 can produce another feedback metric by using the prioritization curve and the estimate of P_{Proposals}. This metric is a performance-based metric that can be used in steps 105 and 125 of FIG. 1. To appreciate how the software program in step 420 produces this metric, it is noted, and as mentioned above, that the software program in step 420 can produce data points (C, QPS) wherein QPS and P_{Proposals} are the two factors on the left side of the odds version of Bayes' law:

$$\frac{{P}_{Proposals}}{1 - {P}_{Proposals}} * Q P S = \frac{{P}_{Results}}{1 - {P}_{Results}} .$$

For any cutoff value, the software program in step 420 can use the estimate of P_{Proposals} and the data points (C, QPS) to estimate the value of P_{Results} that is produced by a cutoff value.

Thus, the software program in step 420 can present this metric in two ways. First, the software program in step 420 can create a set of data points (C, P_{Results}) and then plot the data points to create a graph that predicts the values of P_{Results} that are produced from the cutoff values. This graph can be presented electronically on a computer display or printed in a report. Second, the estimated parameters and the modifications of the segments can be placed in a computer file for use by other software, such a PPM software. The other software may enable a user to input cutoff values and receive the predicted value of P_{Results}. To identify this metric, whether it is presented as a graph or as an algorithm that is programmed into software, a portfolio success rate curve is defined. If the portfolio success rate curve is used as an algorithm in PPM software, the PPM software can use the estimate of P_{Results} to derive qualities of a portfolio of completed projects.

In at least two ways, PPM executives can use the portfolio success rate curve presented to them by the software program. First, they can use the curve to select a cutoff value that produces a desired value of P_{Results}. When used this way, the portfolio success rate curve is a performance-based metric that supports step 125 of FIG. 1. Second, PPM executives can use this curve to evaluate strategy. They can determine if a strategy that calls for aggressive project selection reduces P_{Results} too much thereby causing negative impact to financial performance. When used this way, the curve generated by the software program is a performance-based metric that supports step 105 of FIG. 1.

The software program in step 420 can produce yet another feedback metric by exploiting the version of Bayes' law that is for continuous distributions. This form of Bayes' law takes a proposal's score and estimates the probability that the proposal is successful (a Good proposal). By using this version of Bayes' law and the estimates of g and b, the software program in step 420 can create data points (s′, p(Good|s′)), where the scores, s′, are from the transformed scale. By using the modifications of the segments that were recorded in step 415, the software program in step 420 can convert the transformed scores to the original scale and produce data points (s, p(Good|s)).

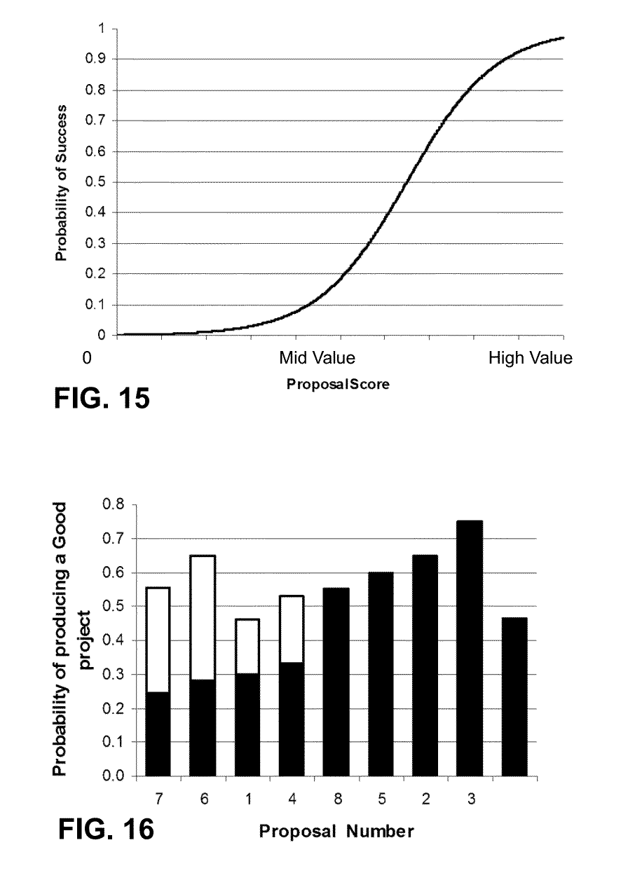

With either set of data points, the software program in step 420 can plot the data points to create a graph that shows how the probability of success depends upon a proposal's score (or transformed score). FIG. 15 illustrates the graph produced by plotting the data points (s′, p(Good|s′)), which graph has an S-curve shape. It is to be appreciated that if the data points (s, p(Good|s)) are plotted, the curve is not smooth, in contrast to the curve in FIG. 15. The software program in step 420 can preferably present the graph electronically, perhaps on a display that is connected to the computer executing the software program. Alternatively, the software program in step 420 can instruct the computer to print the graph on paper, perhaps as part of a report on PPM.

Additionally, the software program in step 420 can place the estimated parameters and the modification of the segments into a computer file for use by another software program. The other software may enable a user to input a proposal's score and receive an estimate of the proposal's chance of success. It is to be understood this metric is identified as a “project success curve”, whether it is presented as a graph or as an algorithm that is programmed into software. If the project success curve is programmed into PPM software, the software could use proposal scores to estimate qualities of project portfolios, such as portfolio risk.

It is to be appreciated that PPM executives can use project success curves in at least two ways. First, project success curves evaluate project evaluation. A steeper S-curve implies better project evaluations. When used for this purpose, a project success curve is an evaluation metric for step 115 of FIG. 1. Second, PPM executives can use project success curves to predict the probability of success for each proposal that they evaluate. These estimates help the executives manage portfolio risk when they are selecting proposals. When used for this purpose, a project success curve is a performance-based metric for steps 125 of FIG. 1.

Programming the project success curve into software, which can be the software program that runs the illustrated embodiment, can produce yet another feedback metric. However, this metric places an additional requirement on the appropriate PPM implementation(s) since it can only be produced if the appropriate PPM implementation(s) consider resources allocation when evaluating proposals. It is noted that the resource allocation can affect the evaluations of proposals since the amount of resources allocated to a proposal can be an attribute in a scoring model or a decision node in a decision tree or decision analysis model. In either case, the amount of resources allocated to a proposal can be measured as a percent of the maximum amount of resources the proposal can consume. Alternatively, the amount of resources allocated to a proposal can be measured with a five point scale ranging from poor support to full support.

It is to be appreciated that if the amount of resources allocated to a proposal affects the proposal's evaluation, a project success curve produced by the software program can estimate how different amounts of resources affect a proposal's chances of success, which estimation has two parts. First, it is preferable a proposal be evaluated multiple times, each time with a different amount of resources committed to the proposal. Second, for each evaluation, the project success curve estimates the proposal's chance of success. FIG. 16 illustrates a chart that is produced by this procedure. For a proposed allocation of resources, FIG. 16 identifies the estimated probability of success for eight proposals. These probabilities are displayed by the dark bars. Four of the proposals have low probabilities of success because the proposed resource allocation provides them with scant resources. These are projects 7, 6, 1 and 4. FIG. 16 depicts the probabilities of success that these proposals would have if these proposals were fully funded. These probabilities are shown with white bars that sit on top of the black bars. The chart is a performance-based metric for use in step 130 of FIG. 1.

### OTHER EMBODIMENTS

The previously illustrated embodiment fits a new model of project selection—Bayes' law and SDT—to the data collected by the software program in steps 405 and 410. However, in the statistics literature there are many models that can be fit to data by a maximum likelihood technique that overcomes the MDP in PPM. Some of these models and maximum likelihood techniques can be found in sophisticated statistical software, such as SAS and SPSS. While these models have not previously been used with PPM, they are useful in connection with embodiments of the present invention.

To illustrate one example, the following software program in accordance with an embodiment of the present invention produces a project success curve. This embodiment models the relationship between proposal evaluations and the success of completed projects. In this embodiment, steps 405 and 410 in the software program are performed as described above, but with one exception. Step 405 only collects information about selected projects. Together, steps 405 and 410 collect the data displayed in rows two through eight of FIG. 11. This information is processed in step 415 after its input in the software program.

In this embodiment, the software program in step 415 requires a model that relates project evaluation to project results. Furthermore, the algorithm used by the software program that fits the model to the data must overcome the MDP in PPM. For this embodiment of the software program of the present invention, the model is the logistic model, and the maximum likelihood technique that fits the model is logistic regression.

It is to be understood that a fitted logistic function is a project success curve which logistic function has the shape of an S-curve. Using the model and the fitted parameters, the software program in step 420 is enabled to produce feedback metrics by using the same methods that were presented when describing how the illustrated embodiment produces project success curves, as described above. Thus, the software program in step 420 can create and plot data points (s, p(Good|s)), or can place the estimated parameters into a memory storage device for use by another software program.

Numerous models can model various aspects of PPM, and for each model there can be a maximum likelihood technique that overcomes the MDP in PPM. In these cases, the software program in steps 405 and 410 gather data for fitting the model. Step 415 can use the maximum likelihood technique to fit the model to the data, and step 415 can produce feedback metrics by using the estimated parameters.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A computer-implemented method for producing an objective feedback metric for an aspect of a Project Portfolio Management (“PPM”) implementation that has already been made, the method overcoming a sample selection bias that resulted from a project selection in which a portion less than 100% of a set of proposals had been selected and in which the selection was non-random, wherein the PPM implementation undergoes processing, prior to the inventive method, including:
collecting into a memory of a computer evaluation data about a plurality of rejected project proposals that were available to be selected during project selection and a plurality of selected proposals; and
classifying each of a plurality of the selected proposals as either a good proposal or a bad proposal and entering the classifications into the memory of the computer, each classified proposal being classified based on results produced by implementation of same,
the method comprising the steps, after the PPM implementation has been made, of:
estimating any and all parameters of a distribution of evaluations that the PPM implementation made about at least one aspect of the good proposals as a first density function, using a processor of the computer, the good proposals including the good proposals that were rejected and the good proposals that were selected by the PPM implementation;
estimating any and all parameters of a distribution of evaluations that the PPM implementation made about at least one aspect of the bad proposals as a second density function, using the processor of the computer, the bad proposals including the bad proposals that were rejected and the bad proposals that were selected by the PPM implementation, the first and second density functions overlapping each other; and
estimating, using the processor of the computer, at least one of a fraction of proposals that were evaluated by the PPM implementation which comprise the fraction of evaluated proposals that are good proposals, namely, Pₚᵣₒₚₒₛₐₗₛ, and a fraction of evaluated proposals that are bad proposals, namely, 1−Pₚᵣₒₚₒₛₐₗₛ;
calculating, with a processor of the computer, a likelihood of certain rejected project proposals producing their respective evaluation data that was collected into the memory, the likelihood calculation being made on the basis of the estimated parameters and the estimated fraction of proposals;
using a maximum likelihood technique with a processor of the computer to fit the distributions' respective parameters and the fraction of proposals to the evaluation data and the classifications, the fitting process configuring the processor to overcome the sample selection bias, that resulted from the project selection selecting in a nonrandom manner less than 100% of the set of proposals, by including the likelihoods of said rejected project proposals that were calculated in the calculating step;
producing the feedback metric by using at least one of the estimated parameters; and
outputting the feedback metric from the computer onto a display.

2. The method as recited in claim 1 further including the step of using the computer to display a generated estimated parameter and storing the estimated parameter into the memory of the computer for use by another computer-implemented method.

3. The method as recited in claim 1, wherein the producing the feedback metric step includes generating data points from the generated estimated parameters and presenting the data points to a user.

4. The method as recited in claim 1, wherein the producing the feedback metric step includes generating data points from the generated estimated parameters and storing the estimated parameter into the memory of the computer for use by another computer-implemented method.

5. The method as recited in claim 1, wherein the feedback metric produced is a performance-based metric.

6. The method as recited in claim 1, wherein the feedback metric produced is an evaluation metric.

7. The method as recited in claim 1, wherein the step of collecting data about a plurality of project proposals includes collecting values produced by evaluating the plurality of project proposals wherein the produced values are selected from the group consisting of ratio and interval scales.

8. The method as recited in claim 1, wherein the step of generating estimated parameters estimates the value of the parameters of the model by using an EM algorithm.

9. The method as recited in claim 1, wherein the step of producing the feedback metric uses the density functions to produce a prioritization curve.

10. The method as recited in claim 1, wherein the feedback metric produced is a portfolio success rate curve of estimated values of P_{Results} for the set of project proposals that had been evaluated by the PPM implementation, the method including the further step of providing a predicted value of P_{Results} as function of an input cutoff value using the estimated parameters.

11. The method as recited in claim 1, wherein the feedback metric produced is a project success curve.

12. The method as recited in claim 1, wherein the feedback metric relates resources committed to a proposal to the proposal's probability of success.

13. The method as recited in claim 1, wherein the calculating step calculates the likelihood of substantially all of the rejected project proposals producing their respective evaluation data that was collected into the memory.

14. The method as recited in claim 1, wherein the calculating step calculates the likelihood of each rejected project proposal producing its respective evaluation data that was collected into the memory.
